(19) United States
(12) Patent Application Publication
(10) Pub. No.: US 2009/0313212 A1
(43) Pub. Date: Dec. 17, 2009

(54) RELATIONAL DATABASE WITH COMPOUND IDENTIFIER

(75) Inventor: Brian Aust, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/141,052

(22) Filed: Jun. 17, 2008

(51) Int. Cl. G06F 7/06; G06F 17/30

(52) U.S. Cl. 707/2; 707/102; 707/E17.008

(57) ABSTRACT

A relational database system. The system includes a relational database configured to store and present data in a plurality of tables and a database application operatively coupled with the relational database. The system is configured to execute in an intermediate language runtime environment that supports native treatment of user data type definitions, and the database application and the relational database are configured to populate the plurality of tables with records that are each uniquely identified by a key. For each record, the key is constructed in accordance with a compound user-defined data type, such that the key includes: identification of an originating table and additional record-identifying information for the record.

### BACKGROUND

The idea of unique identity is often implemented in a normalized and indexed relational storage system, such as a relational database. In order to retrieve individual rows from a table in a relational database, a row typically is identified via a unique column value or by some unique combination of column values. In database parlance, such uniqueness is commonly referred to as a “key.”

Database keys may be used for various purposes, including facilitating the manipulation of records stored within the database. For example, database keys may be employed within an application programming interface (API) that interacts with the database, to allow the API to retrieve selected records from the database. In such a setting, the selection, design, and implementation of the key can significantly affect the usability of the database and the way in which an API or other object/entity interacts with the database.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

The present description provides for a relational database system and method. The system includes a relational database configured to store and present data in a plurality of tables and a database application operatively coupled with the relational database. The system is configured to execute in an intermediate language runtime environment that supports native treatment of user data type definitions. In particular, a compound user-defined data type is employed for key instances for the database, and the compound type is constructed in conjunction with the runtime environment so that the compound keys are supported as native data types. For each record, the key is constructed in accordance with the compound user-defined data type, and includes: identification of an originating table and additional record-identifying information for the record.

### BRIEF DESCRIPTION OF THE DRAWINGS

FIG. 1 schematically depicts a computing system and relational database system according to the present description.

FIG. 2 depicts an exemplary table in a relational database according to the present description, and a compound key configured to uniquely identify the table, and uniquely identify a particular record originating on the table.

FIG. 3 depicts an exemplary method for creating and handling data in a relational database.

### DETAILED DESCRIPTION

A relational database system is disclosed. The system can be used to enable more direct and efficient reference to records in tables of the underlying relational database. In particular, the system may be configured so that records in the database are uniquely identified with a compound identifier. A portion of the identifier operates to identify the particular table in the database with which a record is associated.

Accordingly, when the identifier is encountered external to the actual database, such as within higher-level API code, the associated table for a record is easily determined from the identifier itself. In retrieval operations, this allows a desired record to be efficiently accessed from the table on which it resides. Relational databases commonly include many tables, and this improvement in references to database records can be a significant advantage. In addition, knowledge of the originating table for a record can permit other information about the record to be easily learned (e.g., based on knowledge of the various tables in the database and the types of data they contain).

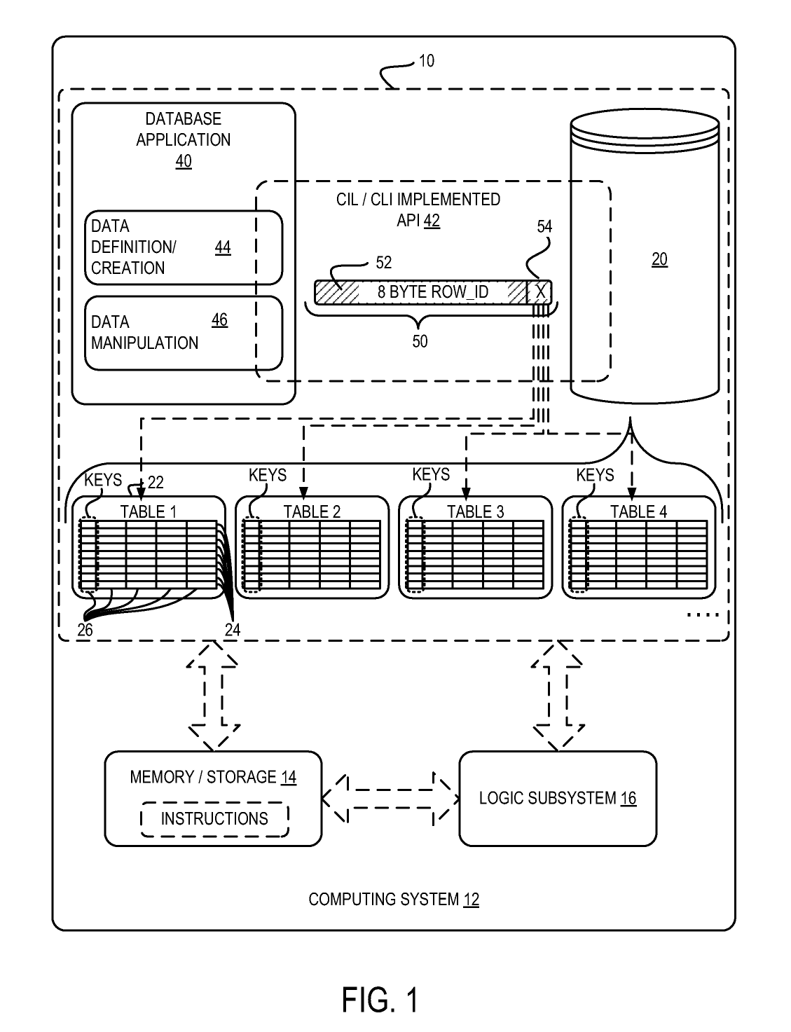

FIG. 1 schematically shows a nonlimiting example embodiment of a relational database system 10 according to the present description. In particular, FIG. 1 schematically shows a computing system 12 that includes memory/storage 14 and logic subsystem 16 for running relational database system 10.

Logic subsystem 16 may be configured to execute one or more instructions, including instructions responsible for providing the herein described relational database functionality. For example, the logic subsystem may be configured to execute one or more instructions that are part of one or more programs, routines, objects, components, data structures, or other logical constructs. Such instructions may be implemented to perform a task, implement an abstract data type, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Memory/storage 14 may include one or more devices configured to hold instructions that, when executed by the logic subsystem, cause the logic subsystem to implement the herein described methods and processes. Memory/storage 14 may include volatile portions and/or nonvolatile portions. In some embodiments, memory/storage 14 may include two or more different devices that may cooperate with one another to hold instructions for execution by the logic subsystem. In some embodiments, logic subsystem 16 and memory/storage 14 may be integrated into one or more common devices and/or computing systems.

Relational database system 10 includes a relational database 20 configured to store and present in one or more tables 22. The data typically is organized as a plurality of records 24 that populate the various tables. For clarity of illustration, only one of the tables depicted in FIG. 1 are designated with reference numbers 22 and 24, though it should be understood that the other tables are similar in many respects to the designated table and are populated with a plurality of records 24. Relational database 20 may include one table, the database will typically be of much greater complexity, and the design and population of the data store will often include establishing many tables.

Relational database 20 provides a data store constructed in accordance with relational principles. In particular, as indicated above, the data is stored and presented in tables 22, with each table having a set of columns 26. Typically, each column is identified by a name unique within the table, and is specified to include data items of a well-known type employed in the relational system (i.e. integer, text, date, etc.). The rows within the tables 22 correspond to records 24 of relational database 20.

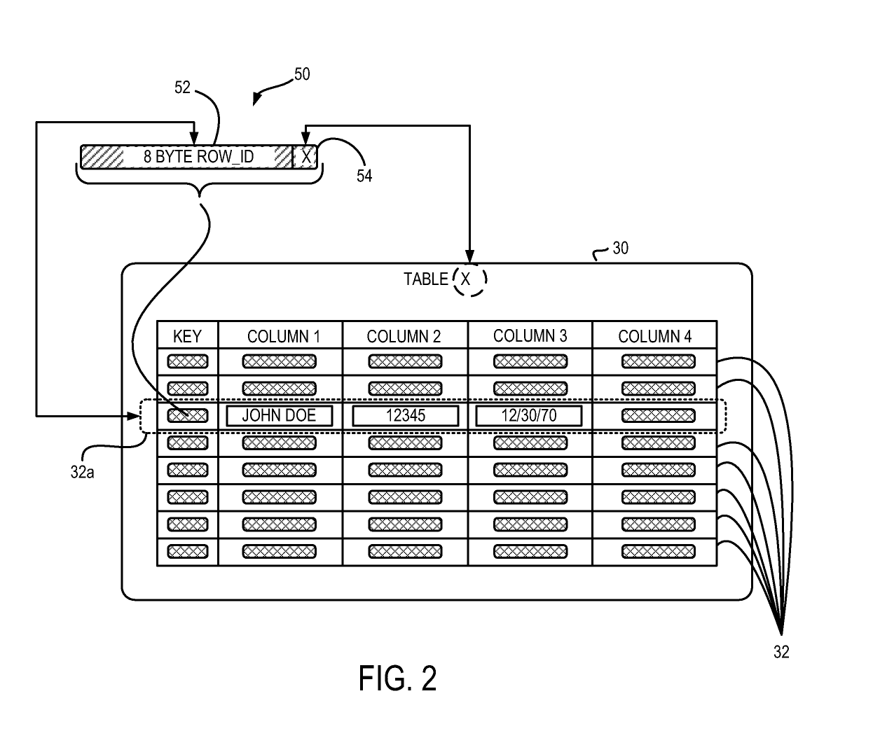

In a typical example embodiment, each table of relational database 20 would represent a concept such as “employee”, “business partnership”, “product,” etc. The columns in each table would contain properties about those concepts. FIG. 2 shows an example table 30 of relational database 20. Assuming table 30 were an “employee” table, the columns of the table might refer to attributes or properties of employees listed in records on the table. Such attributes might include “employee name,” employee ID number,” “hire date,” etc. The collection of column values for a particular row in one of the tables constitutes a record of the database. Table 30 thus contains a plurality of records 32. As shown in the figure, an example employee record 32a could be “John Doe” (employee name); “12345” (employee ID number); “12-30-1970” (hire date).

Various relations between the tables of relational database 20 may be created. For example, the “product” table of the above example might include a column that identifies the responsible sales manager for the product. The identification could be by “employee ID number,” thereby creating a relationship or link between the “product” table and the “employee” table. By relating the rows of the tables together through their various columns, relational database 20 may provide an entire relational information system.

Relational database system 10 also includes a database application 40 and/or database API 42 (application programming interface) operatively coupled with relational database 20. These components may be configured to provide varying functionality in connection with relational database 20, including, by way of non-limiting examples: creating and modifying database schema; querying and making changes to the data (e.g., by inserting, deleting or modifying records/rows in the database tables); menus, user interfaces, data entry screens; reporting tools; data security and access control; data backup and recovery; etc. In particular, as indicated, database application 40 and/or database API 42 may include a data definition/creation module 44 for structurally managing relational database 20. In addition, a data manipulation module 46 may be provided for adding, deleting or modifying records in the database, and/or for performing data retrieval operations.

Database application 40 and/or database API 42, and relational database 20 typically are configured to populate tables 22 with records that are each uniquely identified by a key. In order to retrieve individual rows (records) from a table in a relational database, a row is identified via a key comprising a unique column value or some unique combination of column values.

The key may then be employed for various purposes in database application 40, database API 42, or other settings external to the data store itself. In particular, it will often be desirable to employ a persistence model, in which the database keys are persisted external to the database.

With such persistence, objects or other entities can be employed which include or contain keys from relational database 20. When such an object is encountered, the key may be employed to access the associated record contained in the underlying database. For example, the key can be employed in an API call to relational database 20, which results in searching through all of the records in tables 22 until the key and associated record are encountered. The retrieved record is then available for external use, such as for display in a reporting utility or performance of an operation on one or more fields of the record.

In many cases, the relationship of a given record to the database schema (e.g., its location on a particular table) will have little or no relevance within database application 40 and/or database API 42. Access and retrieval of records may occur infrequently, for example, or the application/API performance may be determined predominantly by factors other than references to the underlying database.

In other settings, various benefits may be obtained through ready determination of the relationship between a given database record and the database schema. Accordingly, the example embodiments provided for herein are configured so that they keys for the database records are implemented as compound identifiers. More particularly, the key for each record is constructed so that the key includes identification of the originating table for the record.

Referring again to FIG. 2, the data pertaining to record 32a is provided in one of the rows of the table, specifically the third row in this example. Key 50 is associated with and uniquely identifies record 32a. In particular, key 50 is compound, and includes a table identifier 52 that identifies table 30. Key 50 may also include additional record-identifying information, such as row identifier 54. All of the records 32 of table 30 include a similarly constructed key, as shown in the leftmost column of the exemplary table.

Indeed, relational database system 10 may be constructed so that all database records, or at least a particular subset of them, are identified with such a compound key. Referring to FIG. 1, the leftmost columns of Tables 1-4 contain compound keys such as that described herein.

According to one implementation, whenever a record is added to relational database 20 (e.g., via addition of a row to one of tables 22), the table identifier and the row identifier of the compound key are automatically generated. For the added record, the table identifier serves to provide an identification of the originating table for the associated record, and operates collectively with the row identifier to uniquely identify the added record within relational database 20.

In other words, in the multiple table system of FIG. 1, tables 22 are populated with a plurality of database records 24, each of which have an associated compound key 50 that uniquely identifies the record within the overall database. The compound key for each record is constructed to include a table identifier 54 which indicates the originating table for the record. As indicated by dashed arrows, table identifier 54 of FIG. 1 can specify any one of Tables 1-4, thereby indicating that the key and its associated record originate from the indicated table.

Each key further includes a row identifier 52 which specifies the particular row on the originating table where the record is located. In some implementations, the row identifiers may repeat. For example, a key for a record on Table 1 could have a row identifier equal in value to that found in a Table 2 key. On the other hand, the keys may be constructed so that the row identifiers themselves are unique across the entire database.

The ability of the compound key to readily identify the table associated with a given record can provide various advantages. For example, software or other systems that interact with relational database 20 may be designed to make use of the compound keys. For example, upon encountering an object containing a compound key such as that described herein, database API 42 can leverage knowledge of the originating table to make a more direct and efficient reference to relational database 20. This type of improved database access can improve access times and reduce coupling between APIs or other components and the database.

Furthermore, encoding of the table identity in the database key may be useful if knowledge pertaining to the database schema is available. For example, it might be known to a designer of an API or other external code that certain tables in the underlying database contain particular types of records having particular characteristics. Then, in an API or other setting external to the underlying database, the table identifier of the compound key allows characteristics of a database record to be determined directly without having to access or retrieve the actual record from the database.

The compound keys described herein may be implemented in a variety of ways. In some implementations, standard native data types are employed for the compound key, such as the numeric, text and other scalar types that are available in SQL and other database systems. For example, numeric keys can be allocated so that different key value ranges correspond to different tables in the database. In another example, keys may be typed using custom text formatting.

In other example embodiments, a compound user-defined data type is employed in an intermediate language runtime environment that supports native treatment of the compound user-defined data type and other user data type definitions. In the example of FIG. 1, database application 40 and database API 42 are executable and configured for use in a Common Language Infrastructure (CLI) runtime implementation. In particular, the NET CLR (Common Language Runtime) has been successfully employed in connection with the systems described herein.

In connection with this runtime environment, the compound key is constructed according to a compound user-defined data type that combines the previously described table identifier and row identifier into a compound key. The data type is constructed and defined so as to be available via native treatment as a first class type within the type system or systems employed on computing system 12.

The native, first class treatment of the data type allows the compound keys to provide fast and efficient indexing and retrieval of database records. Furthermore, as explained in more detail below, the data type is configured so that table identifier 54 and the other record identifying information can be readily obtained from the compound key without parsing, thereby avoiding the processing time and performance deficits often incurred through use of parsing routines.

In particular, as in the examples of FIG. 1 and FIG. 2, the compound user-defined data type is configured to provide for a nine-byte aggregate key. Table identifier 54 comprises one byte of the aggregate, while the row identifier 52 comprises the other eight bytes. The values for a particular instance of the key are typically generated automatically upon addition of a row (record) to one of the tables of relational database 20. Furthermore, table identifier 54 may be disposed in a separate predefined location of the key (e.g., byte position), to facilitate parsing-free access to that component of the key. Use of this fixed-byte length compound identifier across the database system and the placement of the table identifier in a separate predefined section of the key can significantly improve the efficiency of references to the database, for example by database API 42.

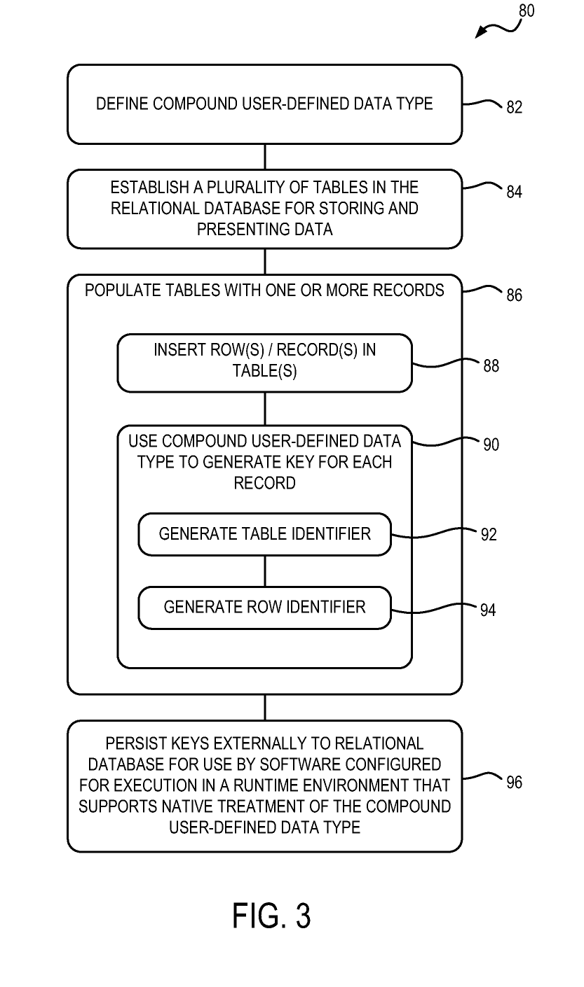

From the above, it will be appreciated the description further encompasses a method of creating and handling data in a relational database. In particular, FIG. 3 depicts an example method 80 according to the present description. At 82, the method includes defining a compound user-defined data type. At 84, the method includes establishing a plurality of tables in the relational database for storing and presenting data. At 86, the method includes populating the relational database with one or more records. As shown at 88, populating the database may include inserting one or more additional rows (records) into the tables of the relational database. The compound user-defined data type is used at 90 to generate a key for each record. As shown at 92 and 94, generating the key may include generating a table identifier and a row identifier, as previously described in connection with FIG. 1 and FIG. 2.

Continuing with method 80, as shown at 96, the method may further include persisting the keys externally to the relational database for use by applications, APIs, etc. that are configured for use in and support an intermediate language runtime environment that supports native treatment of the compound user-defined data type. For example, as shown in FIG. 1, key 50 is persisted external to relational database 20, and is available for use within database API 42. In particular, the key is usable by the API to facilitate access to and retrieval of the corresponding record from the database. Specifically, upon encountering an object containing a key, database application 40 may use the key in an API call with database API 42 to retrieve the associated database record.

It will be appreciated that the computing devices described herein may be any suitable computing device configured to execute the programs described herein. For example, the computing devices may be a mainframe computer, personal computer, laptop computer, portable data assistant (PDA), computer-enabled wireless telephone, networked computing device, or other suitable computing device, and may be connected to each other via computer networks, such as the Internet. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A relational database system, comprising:
a relational database configured to store and present data in a plurality of tables; and
a database application operatively coupled with the relational database and configured to execute in an intermediate language runtime environment that supports native treatment of user data type definitions, where the database application and the relational database are configured to populate the plurality of tables with records that are each uniquely identified by a key, and where for each of the records, the key is constructed in accordance with a compound user-defined data type, such that the key includes: identification of an originating table for that record, the originating table being one of the plurality of tables; and additional record-identifying information for that record.

2. The system of claim 1, where the intermediate language runtime environment is a Common Language Infrastructure implementation.

3. The system of claim 2, where the intermediate language runtime environment is NET Common Language Runtime.

4. The system of claim 1, where the database application includes an API implementation configured to use the identification of the originating table to query the relational database.

5. The system of claim 1, where the compound user-defined data type is defined so that, for each of the records, the identification of the originating table is in a separate predefined section of the key, thereby enabling determination of the identification of the originating table without parsing.

6. The system of claim 5, where the compound user-defined data type is defined so that the key for each of the records has a fixed byte length.

7. The system of claim 1, where for each of the keys, the additional record-identifying information is an identification of a row within the originating table.

8. The system of claim 7, where for each the keys, the identification of the originating table and the identification of the row within the originating table collectively result in unique identification of the record.

9. A method of creating and handling data in a relational database, comprising:
defining a compound user-defined data type;
establishing a plurality of tables in the relational database for storing and presenting data;
populating the plurality of tables with a plurality of records, where for each of the plurality of records, said populating includes: inserting an additional row into one of the plurality of tables, said additional row containing data pertaining to that record;
using the compound user-defined data type to generate a key which uniquely identifies that record and uniquely identifies the one of the plurality of tables; and
persisting the keys for the plurality of records into a database API that is executable and configured for use within an intermediate language runtime environment that supports native treatment of the compound user-defined data type.

10. The method of claim 9, further comprising:
using the database API to retrieve one of the plurality of records from the relational database.

11. The method of claim 9, further comprising:
receiving one of the keys with the database API, and using the database API to determine a characteristic of the record that is uniquely identified by the key.

12. The method of claim 11, where the characteristic is associated with the table that is uniquely identified by the key.

13. The method of claim 9, where using the compound user-defined data type to generate the key includes automatically generating a row identifier and automatically generating a table identifier.

14. The method of claim 13, where using the compound user-defined data type to generate the key includes locating the table identifier in a separate predefined section of the key, thereby enabling retrieval of the table identifier without parsing of the key.

15. The method of claim 14, where the keys have a fixed byte length.

16. The method of claim 9, where the intermediate language runtime environment is a Common Language Infrastructure implementation.

17. A method of creating and handling data in a relational database, comprising:
establishing a plurality of tables in the relational database for storing and presenting data;
adding a record to one of the plurality of tables in the form of an additional row to the table;
generating a table identifier for the table to which the record is added;
generating a row identifier for the additional row corresponding to the record;
using a compound user-defined data type to combine the table identifier and the row identifier into a key which uniquely identifies the record; and
retrieving the record from the table by providing the key to a database API executed and configured for use within an intermediate language runtime environment that supports native treatment of the compound user-defined data type.

18. The method of claim 17, where using the compound user-defined data type to combine the table identifier and the row identifier into the key includes locating the table identifier in a separate predefined section of the key, thereby permitting retrieval of the table identifier without parsing of the key.

19. The method of claim 17, where the intermediate language runtime environment is a Common Language Infrastructure implementation.

20. The method of claim 17, further comprising:
adding a plurality of additional records to the plurality of tables; and
using, for each of the plurality of additional records, the compound user-defined data type to provide a key which uniquely identifies that additional record, whereby the record and all of the plurality of additional records are uniquely identified by corresponding keys.
